(19) United States
(12) Patent Application Publication
(10) Pub. No.: US 2001/0035211 A1
(43) Pub. Date: Nov. 1, 2001

(54) Combination of non-return valve with a device

(76) Inventor: Sandor Palvoelgyi, Gleisdorf (AT)

Correspondence Address: Magna International of America, Inc., 600 Wilshire Drive, Troy, MI, 48084-1625, US

(21) Appl. No.: 09/770,120

(22) Filed: Jan. 26, 2001

(30) Foreign Application Priority Data
Jan. 26, 2000 (AT) GM47/2000

(51) Int. Cl. F16K 31/18

(52) U.S. Cl. 137/434

(57) ABSTRACT

The invention relates to a combination of a check valve for preventing the backflow of fuel from a fuel tank with an apparatus for limiting the fill level. The check valve is fixed to the end segment, projecting into the fuel tank, of a filler pipe and has a movable valve part exposing an inlet opening. The apparatus for limiting the fill level is arranged, viewed from the fuel tank, in front of the check valve and has a flap capable of closing an inlet opening and being actuated by a float. The flap, which is capable of closing the inlet opening is operatively connected to the rotatably mounted float via a transmission linkage in such a way that a comparatively slight rotation of the float will bring about a much greater rotation of the flap to adopt the closed position.

### BACKGROUND OF THE INVENTION

The invention relates to a combination of a check valve for preventing the backflow of fuel from a fuel tank of a motor vehicle with an apparatus for limiting the filling level, the check valve being fixed to the end segment, projecting into the fuel tank, of a filler pipe and having a movable valve part exposing an inlet opening, and the apparatus for limiting the fill level, viewed from the fuel tank, is located in front of the check valve and has a flap that is capable of closing an inlet opening is actuated by a float.

A known combination of this type has a check valve similar to a heart valve and an apparatus, actuatable by a float, to limit the fill level. However, this apparatus requires a relatively long travel of the float for actuation, and therefore reacts slowly when the desired fill level of fuel in the tank is reached. The check valve used is not impermeable to liquids and cannot therefore prevent fuel from leaking from the tank to the exterior via the filler pipe in the event of damage to the filler pipe or the fuel cap, which can arise during an accident.

A one-way check valve assembly for use in a fuel filler pipe to prevent liquid fuel from backing up the filler pipe is disclosed in U.S. Pat. No. 5,518,026. The check valve assembly includes a valve member formed from a flexible membrane, which is normally biased to a closed position to seal against the interior surface of the filler pipe, and forced open during refueling by the flow of fuel. The valve member is a butterfly or V-shaped membrane formed about a central pivot member in the filler pipe. The individual wings or flaps of the valve member are semi-elliptical and in the closed position are angled downstream from the pivot point, sealing with the filler pipe shape in angular sections or shoulders formed in the interior sidewall. After re-fueling of the tank, or when the tank is sufficiently full that fuel begins to flow back, the two wings are again pressed against their seating surfaces, closing the fuel inlet opening. A specific volume or fill level of fuel in the tank cannot be controlled with this design, so that overfilling of the tank may potentially occur. Valves of this design are, in addition, not very liquid-tight.

German patent specification DE 96 50 194 C1, which is equivalent to U.S. Pat. No. 5,950,692, discloses an apparatus for limiting the fill level in a fuel tank that has a valve flap controlled by a float. The flap is so arranged that it is pivoted toward the flow of fuel entering the tank during refueling and is connected, by way of a crank arm and a coupling rod, to a float. The flap is fully opened because of the weight of the float at the beginning of a normal fuel tank refueling. As the fuel level in the tank rises, the buoyancy force eventually overcomes the weight force and the float lifts the coupling rod and crank arm, which causes a pivoting closing motion of the flap. Once the flap is fully closed, the fuel flowing from the refueling nozzle backs up within the filler neck, causing the refueling nozzle to automatically switch off. The fuel remaining in the filler neck is removed via a narrow gap between the flap and the tank inlet end until the liquid level in the filler neck is the same as the level in the fuel tank. After the excess pressure in the filler neck has been reduced, the flap partially reopens. The design of the interacting parts prevents refilling when the tank is full. Complete opening of the flap and addition of fuel to the tank is only possible after a small amount of fuel has been consumed.

An object of the invention is to provide an apparatus that combines the check valve function and the fill limit function while ensuring a rapid response and reliable operation. A preferred embodiment of the check valve is also intended to provide a tight seal that is impermeable to liquids.

Other objects and advantages of the present invention will become apparent from the following detailed description of the invention when considered in conjunction with the accompanying drawings.

### SUMMARY OF THE INVENTION

This object is achieved, according to the invention, in that the flap capable of closing the inlet opening is operatively connected to a rotatably mounted float via a transmission linkage in such a way that a comparatively slight twisting of the float will bring about a much greater twisting of the flap to adopt the closed position.

The invention thus ensures prompt and reliable closure of the flap when the maximum fuel level in the tank is reached.

In order that the combination according to the invention should be simple to manufacture and fit, the valve part of the check valve and the flap operatively connected to the float are arranged in a housing that is connected to the end segment of the filler pipe.

The check valve is advantageously so designed that the valve part is pressed under the action of at least one spring into the position closing the inlet opening. This is one of those measures that are significant for a liquid-tight seating of the valve part.

In a preferred embodiment of the invention, the flap is centrally and rotatably mounted on the housing. This specific central mounting is particularly advantageous for the purposes of assisting rapid twisting of the flap to close the inlet opening.

The transmission linkage should be of simple, strong and functionally reliable design. To this end, a toothed wheel, which is one of the components of the transmission linkage, is arranged at least on one side of the swivel axis of the flap, outside the housing.

In order to avoid jamming during actuation, it is preferable if a toothed wheel is arranged only on one side of the swivel axis of the flap. A rolling contact part is arranged on the other side of the swivel axis of the flap, outside the housing.

As mentioned above, a small twisting of the float results in a much greater twisting of the flap. The rotatable arrangement of the float is advantageously on the housing itself.

The form taken by the operative connection of the float to the flap can also be a very simple and functionally reliable one whereby the float has a connecting part which is connected at one end to the float housing and is provided at the other end with two arms extending to the side of the housing, of which arms one arm is provided with a toothing in engagement with the toothed wheel or the like. The other arm of the connecting part is so designed that it ensures a sliding movement on the rolling contact part.

A second measure essential for a liquid-tight seating of the valve part when the valve is closed resides in the fact that a seal running around the valve part is arranged thereon, in particular being clamped in, and has a sealing lip which is pressed by the valve part subjected to the action of the spring against a sealing bead on the inside of the housing.

In a preferred alternative embodiment of the invention, the valve part of the check valve is a valve body of at least largely streamlined design and movable in the longitudinal direction of the housing. In this embodiment, a liquid-tight seal can be achieved particularly successfully.

For satisfactory guidance of the valve body in the longitudinal direction of the housing, the valve body is provided externally with a number of guide fins distributed, in particular regularly distributed, on its circumference.

The spring acting upon the valve body is preferably designed as a helical compression spring which is supported at one end in the interior of the housing and at the other end on the guide fins. This ensures that the spring acts centrally on the valve body. The travel of the valve body against the force of the spring can be limited in a simple manner by a stop designed on the inside of the housing.

In another embodiment, the valve part of the check valve may be a valve flap mounted eccentrically and rotatably on the housing. This design is somewhat simpler than the design with a valve body but is not so liquid-tight as the latter.

In an embodiment with a valve flap, a simply designed and easily fitted leg spring may be used to act upon the valve flap.

In order to ensure simple assembly of the check valve or of the component comprising the latter, provision is made for both the housing and the valve part to be of multipart design.

### BRIEF DESCRIPTION OF THE DRAWINGS

FIG. 1 shows a longitudinal cross-section through one alternative embodiment of a check valve with the check valve closed,

FIG. 2 shows a longitudinal cross-section through one alternative embodiment of a check valve with the check valve open during filling with fuel,

FIG. 3 shows a longitudinal cross-section through one alternative embodiment of a check valve showing the check valve and the apparatus for limiting the fill level in a position immediately after the predetermined fuel level has been reached in the tank,

FIG. 4 shows an oblique view of a filler pipe with check valve, partially cut away,

FIG. 5 shows an oblique view of one of the valve housing parts,

FIG. 6a shows an oblique view of the housing part according to FIG. 5 together with the apparatus for limiting the filling level,

FIG. 6b shows an oblique view of the parts shown in FIG. 6a from the opposite side,

FIG. 6c shows an oblique view of a detail of the apparatus for limiting the filling level, and

FIG. 7 shows a longitudinal cross-section through a second alternative embodiment of a check valve with the check valve closed, analogous to FIG. 1.

### DETAILED DESCRIPTION OF THE INVENTION

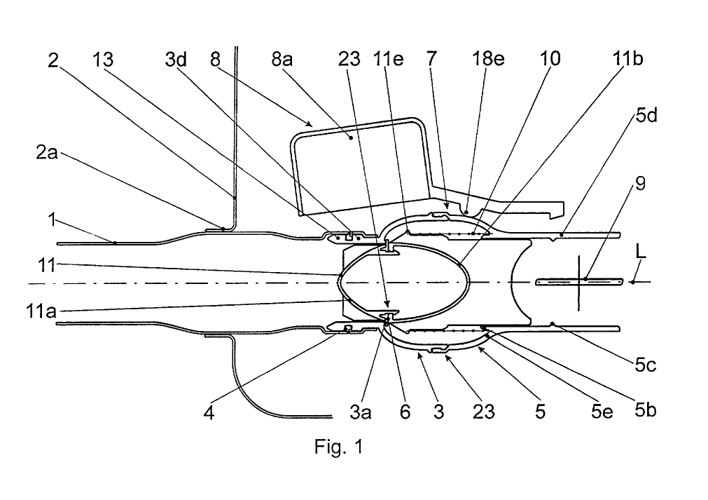

According to the invention, a check valve is combined with an apparatus for limiting the fill level and is located at the end segment of a filler pipe 1, protruding into the interior of the fuel tank 2. Filler pipe 1 passes through a tank inlet opening into the interior of the fuel tank 2 and is connected by welding the exterior pipe surface to the tank edge region 2a which surrounds the inlet opening. As shown in FIG. 1 to FIG. 3, the check valve has a housing 7 which includes two housing parts 3 and 5. The two housing parts 3, 5 are each provided with an end segment 3d, 5d of substantially cylindrical shape and with a connecting segment 3e, 5e of larger diameter, with the two housing parts 3, 5 being connected to one another via an interlocking or snap-in connection 23. The housing 7 is pressed into the end of the filler pipe 1 by means of the housing part 3, whereby a positive interlocking connection is created by a “tongue-in-groove” or snap projection 13 extending along the exterior of the housing part 3 that engages into a complementary recess in the filler pipe 1. A seal 4 is fitted in a groove of the projection 13 and ensures a tight seal between the housing part 3 and the filler pipe 1 that is impermeable to liquids.

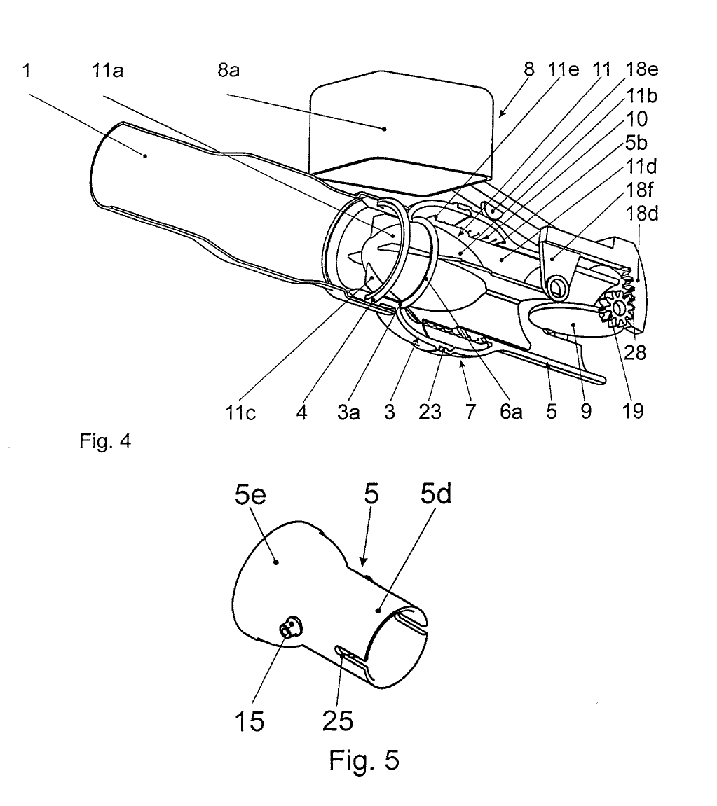

As shown by FIG. 1 in conjunction with FIG. 4, a valve body 11 is accommodated in the interior of the housing 7 and is composed of an inflow part 11a and an outflow part 11b, which impart an egg-shaped or oval form to the valve body 11 as a whole. The two valve body parts 11a, 11b may also be regarded as ellipsoidal or paraboloidal parts fitted together, the inflow part 11a being of sharper design and the outflow part 11b of blunter design. The inflow part 11a is connected to the outflow part 11b via a snap connection 21 with a seal 6 that is placed in between the parts 11a and 11b. The seal 6 is designed with a sealing lip 6a which surrounds the valve body 11, and is pressed under the action of a compression spring 10 against a sealing bead 3a, which is formed at the transition area between the cylindrical end segment 3d and the connecting segment 3e. Such a seal reliably prevents fuel from leaking out of the tank 2 into the filler pipe 1 when the fuel tank is full.

Both the inflow part 11a and the outflow part 11b are in each case provided on the outside with a number of guide fins 11c, 11d extending in the longitudinal direction of the valve body 11. This is particularly apparent from FIG. 4. In the example of embodiment shown, four guide fins 11c and four guide fins 11d are in each case provided and, offset in each case by 90° relative to one another, project from the outside of the parts 11a, 11b, the guide fins 11c not being of a length such as to project beyond the end of the inflow part 11a projecting into the pipe 1. The guide fins 11d on the outflow part 11b are of longer design than the outflow part 11b and extend beyond the valve body 11 into the region 5d of the housing part 5. The guide fins 11c are adapted in respect of their height to the internal diameter of the cylindrical end segment 3d of the housing part 3. The guide fins 11d each form a support shoulder 11e for the compression spring 10, which is supported at the other end on the region of transition from the cylindrical end segment 5d to the connecting region 5e behind a further, circumferential support shoulder 5b. The regions of the guide fins 11d projecting beyond the end of the outflow part 11b are likewise adapted in respect of their diameter to the internal diameter of the cylindrical end segment 5d of the housing part 5. Thus, the guide fins 11c, 11d ensure satisfactory guiding of the valve body 11 when the latter is moved in the direction of the longitudinal axis L to open and close the inlet opening.

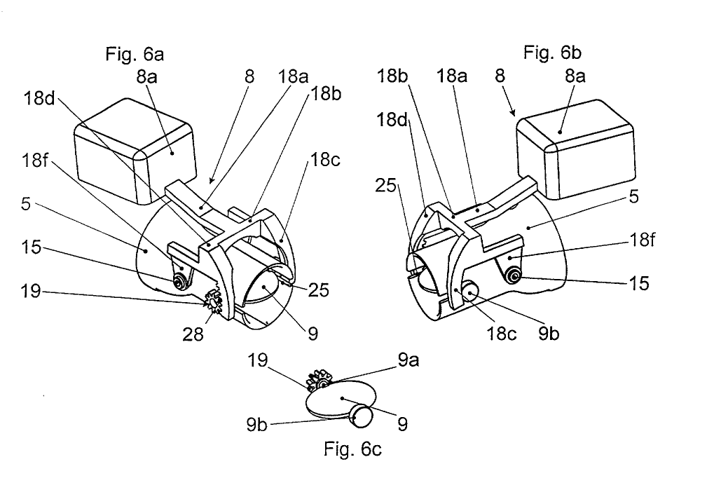

Accommodated in the cylindrical end segment 5d is a flap 9 which closes the inlet opening in the housing part 5 when necessary, is operatively connected to a float 8, and is controlled by the latter. The flap 9 and the float 8 are components of the apparatus according to the invention for limiting the filling level. This will now be explained in detail with reference to FIG. 5 and to FIGS. 6a, 6b and 6c. The float 8 has a float housing 8a which, in a customary manner, is for example of cuboid design and open toward the fuel level, and is connected at the end to the central part 18a of a T-shaped connecting part 18. The crossbar 18d of the T-shaped connecting part 18 is provided at its ends with downward-pointing arms 18c, 18d, which are provided with shoulders pointing in the direction of the float housing 8a and having securing tabs 18f. The float 8 is rotatably mounted on the housing part 5, via the two tabs 18f, by means of bearing pins 15 or the like.

As is particularly apparent from FIG. 5, the housing part 5 may be provided at its region 5d with two slits 25, offset by 180° relative to one another, where the flap 9, designed as a circular disk, is pushed in and rotatably mounted. For this purpose, the flap 9, as FIG. 6c shows, is provided at its edge with stub bolts 9a in alignment across its center point. A toothed wheel 19 is fixed on one of the stub bolts 9a and a cylindrical rolling contact part 9b on the second stub bolt 9a. The stub bolts 9a serve for the rotatable arrangement of the flap 9, pushed into the slit 25, in the region of the inward ends of the slits 25, the toothed wheel 19 lying externally on one side of the housing part 5 and the rolling contact part 9b on the other side.

The float 8 arranged on the housing part 5 by means of the securing tabs 18f engages with the arm 18d over the toothed wheel 19 and with the arm 18c over the rolling contact part 9b. The arm 28d is here provided at the end with a toothing 28, which engages into the pinions of the toothed wheel 19a. The second, opposite arm 18c engages in sliding movable contact over the rolling contact part 9b, as is particularly apparent from FIG. 6b. FIG. 1, FIG. 6a and FIG. 6b show the unactuated situation of the float 8, in which the flap 9, as a result of the operative connection via the toothing 28 and the toothed wheel 19, is located in a position exposing the inlet opening and hence extending along the longitudinal axis L of the pipe 1.

The mode of operation of this embodiment of the check valve coupled with the float is as follows.

As FIG. 1 shows, when the fuel tank 2 is empty or nearly empty, the valve body 11 closes the filler pipe 1 under the action of the compression spring 10. The connecting part 18 of the float 8 rests, by means of a stop 18e formed on the underside of the central part 18a, externally on the housing part 5. In this position, the flap 9, operatively connected to the float 8, completely exposes the inlet opening that can be closed by it.

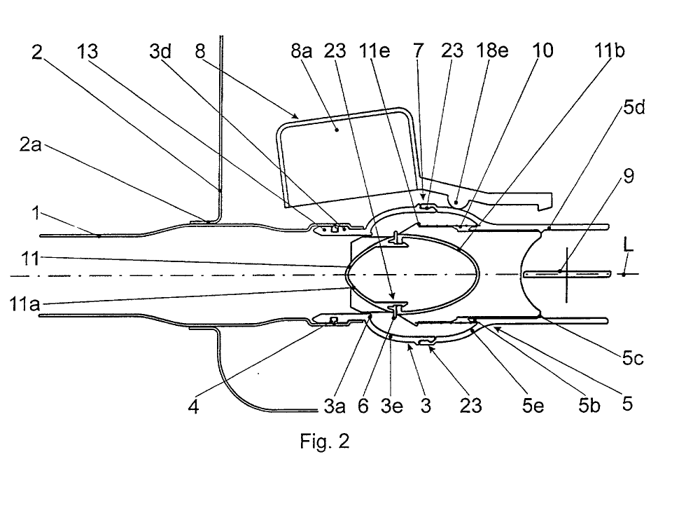

When the tank is filled, the valve body 11 is displaced by the fuel flowing toward the tank 2 within the filler pipe 1 against the force of the spring 10, so that the fuel can pass into the interior of the tank by flowing around the valve body 11. The travel of the valve body 11 is limited here by a shoulder 5c, formed on the inside of the housing part 5, where the ends of the guide fins 11b are supported. The flap 9 initially remains in its position which hardly impedes the fuel flow. FIG. 2 shows this situation, existing while the tank is being filled.

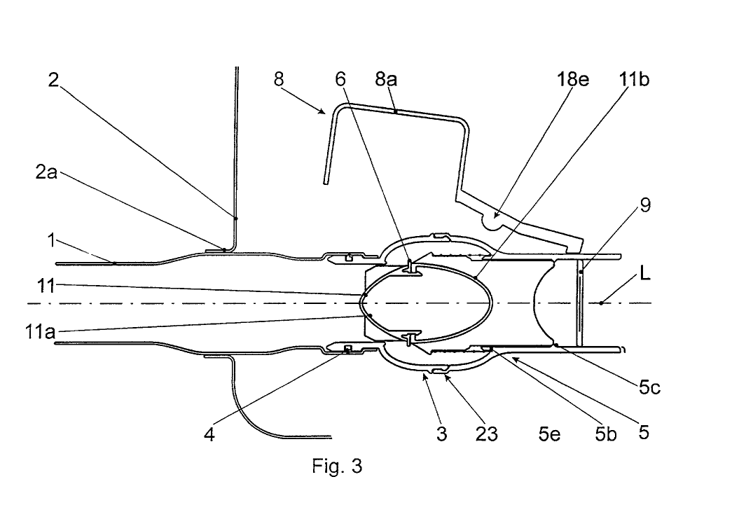

As soon as the fuel level in the interior of the tank reaches a certain height and exerts a certain buoyancy on the float housing 8a, the float 8 is pivoted by the rising liquid in the interior of the tank around the bearing pin 15. As a result, the arm 18d is caused to move and, via its toothing 28 in engagement with the toothed wheel 19, twists the flap 9, which eventually adopts its position closing the inlet opening, which is shown in FIG. 3. The valve body 11, acted upon by the compression spring 10, now returns into its initial position, the closed position.

The arm 8c of the float 8 sliding along the rolling contact part 9b has merely a supporting and guiding function. In principle, a toothed wheel interacting with a toothing could also be provided in this region, similarly to the opposite arm 18d. The advantage of the unilateral drive, however, is that production tolerances cannot result in jamming.

The rolling contact radius of the toothing 28 is greater than the radius of the pinion on the toothed wheel 19, so that the toothed wheel 19 and hence the flap 9 twist through a greater angle than the float 8. The transmission is of course dependent on the respective radial dimensions. The transmission ratio may, for example, be selected as 1:6, so that a twisting of the float 8 through 15° about the axis formed by the bearing pin 15 is sufficient to twist the flap 9 through 90° and hence into a position closing the inlet opening. The closing of the inlet opening thus takes place rapidly and with functional reliability when a particular fuel level is reached or exceeded during filling of the tank with fuel. The transmission ratio may of course be different and varied as required by appropriate design of the dimensions of the parts involved.

In order to control twisting of the flap 9 progressively or regressively, the toothed wheel and the toothing may be of a design which differs from a circular or arcuate shape. In this case, of course, the shape of the rolling contact part 9b and of the arm 18d of the float 8 sliding thereon must be adapted accordingly.

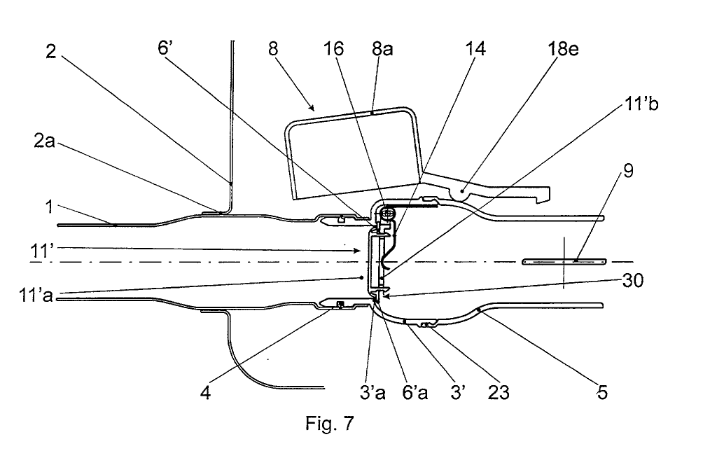

In the second embodiment, shown in FIG. 7, the float 8 and the parts operatively connected thereto are of the same design as in the first embodiment. Therefore, no further separate details will be given of the design of these parts—in particular of the float 8 together with its components, the flap 9 or the housing part 5. Parts which are of the same design as those in the first example of embodiment have also been given the reference numerals from the previous figures of the drawings.

As FIG. 7 shows, a discoidal valve flap 11′ is here provided in place of a valve body. The valve flap 11′ is rotatably mounted in the interior of the housing part 3′ on a pivot 16 and has a valve front part 11′a which is connected via a snap connection 30 to a connecting part 11′b, a seal 6′ being clamped between the latter and the front part 11′b at the edge and provided with an externally circumferential sealing lip 6′a. The sealing lip 6′a is pressed via a leg spring 14 acting upon the connecting part 11′b against a sealing bead 3′a running around the inside of the housing part 3′.

The leg spring 14 is arranged in the region of the joint 16, has a leg supported on the inside of the housing part 3′, and presses with a second leg, which in this case has a curved end section, on the connecting part 11′b.

The fundamental mode of operation of this alternative embodiment is similar to that of the first embodiment, with the exception that the valve 11′ opens and closes by pivoting during refueling.

I claim:

1. A combination of a check valve for preventing the backflow of fuel from a fuel tank of a motor vehicle with an apparatus for limiting the fill level, whereby the check valve is located in the end segment of a filler pipe that protrudes into the fuel tank, and having a movable valve part exposing an inlet opening, and whereby whereby the device for restricting the fill level, when viewed from the fuel tank, is located in front of the check valve and has a flap for closing the inlet opening which can be activated by a float, characterized by the fact that the flap used to closing the inlet opening is connected with the float through a step-up gear in such a manner that a realtively small rotation of the float results in a substantially larger rotation of the flap to obtain the closing position.

2. The combination as claimed in claim 1, wherein the valve part (11, 11′) of the check valve and the flap (9) operatively connected to the float (8) are arranged in a housing (7) which is connected to the end segment of the filler pipe (1).
